(19) United States
(12) Patent Application Publication
(10) Pub. No.: US 2026/0145748 A1
(43) Pub. Date: May 28, 2026

(54) Truck Hood Lever

(71) Applicant: John Baerga, Fredericksburg, VA (US)

(72) Inventor: John Baerga, Fredericksburg, VA (US)

(21) Appl. No.: 18/958,810

(22) Filed: Nov. 25, 2024

(51) Int. Cl. B62D 25/12; B62D 25/10

(52) U.S. Cl. CPC B62D 25/12; B62D 25/105

(57) ABSTRACT

A device for raising a heavy truck engine hood utilizing a lever and connection straps to create a fulcrum allowing a single user to lift the hood.

### CROSS REFERENCE TO RELATED APPLICATIONS

Not applicable.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention is a free-standing lever device for applying force to a truck engine hood.

### Background of the Invention

Before a long-haul trucker leaves his home base for a run, it is essential to open the hood of the truck and spot check all significant engine and related components for damage or leaks. Failure to do so can result in the driver being stranded on the roadside, missing deadlines and perhaps losing business.

The engine hood of a standard semi-trailer or other large truck can weigh around 400-500 pounds. Typically, the hood is first unclipped and then is arranged to tip forward on hinges located behind the front bumper, allowing access to the engine and other under-hood components from the sides. A niche or handle is built into the center of the hood near the front pumper, allowing a user to manually grab the hood and pull it open.

Even for a man of above-average height and weight, the process of opening a hood can be difficult to accomplish alone. Generally, it is required to step up onto the truck bumper to enable the user to fully reach the hood handle and exert the leverage necessary to pull the hood up and forward. The exercise can become impossible when the user is elderly, injured, or of small stature. A significant percentage of long haul drivers are also women, who are likely to have more difficulty due to smaller stature. Especially with constant repetition, the risk of injury can be quite high.

What is needed is a device that will enable an individual user to exert additional foot-pounds of leverage to bring a truck hood upward and forward without assistance. The device and method of use disclosed herein accomplish such a purpose.

### BRIEF SUMMARY OF THE INVENTION

In a preferred embodiment, a truck hood raising device comprising each of an outer tube and an inner tube, wherein the inner tube extends from a first end of the outer tube, a foot attached to an end of outer tube, a hood strap and a hand strap, each attached to the inner tube, wherein the hood strap comprises a hood strap clip for attachment to a truck hood and the hand strap comprises a hand strap handle to be pulled by a user.

In another preferred embodiment, the truck hood raising device as described herein, further comprising a line of outer tube clip holes and a line of inner tube clip holes which slidably overlay as the inner tube is pulled from within the outer tube, and clips which insert into the overlaid clip holes.

In another preferred embodiment, the truck hood raising device as described herein, wherein the clips are push-button snaps.

In another preferred embodiment, the truck hood raising device as described herein, the foot is covered in rubber or an elastomer.

In another preferred embodiment, the truck hood raising device as described herein, wherein the foot comprises a foot stem with a hinge or ratchet.

In another preferred embodiment, the truck hood raising device as described herein, wherein each of the hand strap and hood strap are attached to the inner tube by a clip, and each strap is comprised of high-strength polymer with a tensile strength of 500 pounds or greater.

In another preferred embodiment, the truck hood raising device as described herein, comprising a single tube.

In another preferred embodiment, a method of raising a truck hood using the truck hood raising device as described herein, comprising the steps of:
Extending the inner tube from the outer tube to the desired height and snapping the tubes into place;
Placing the foot onto the ground in front of a truck's front bumper;
Attaching the hood strap clip to the truck's hood; and
Pulling the hand strap handle in a direction away from the truck hood while maintaining a connection between the foot and the ground until the hood is in a full upright and open position.

In another preferred embodiment, the method of use as described herein, comprising the step: d. Pulling the inner and/or outer tube in a direction away from the hood while maintaining a connection between the foot and the ground until the hood is in a full upright and open position.

In another preferred embodiment, the method of use as described herein, comprising the steps of:
Extending the inner tube from the outer tube to the desired height and snapping the tubes into place;
Placing the foot onto a truck's front bumper;
Attaching the hood strap clip to the truck's hood; and
Pulling the inner and/or outer tube in a direction away from the hood while maintaining a connection between the foot and the ground until the hood is in a full upright and open position.

### BRIEF DESCRIPTION OF THE DRAWINGS

FIG. 1 is a line drawing showing the hood opener device as claimed.

FIG. 2 shows an alternate embodiment of the hood opener.

FIG. 3 shows the device of FIG. 2 using a truck bumper for leverage.

FIG. 4 shows the device of FIG. 1 using the ground in front of a truck for leverage.

### DETAILED DESCRIPTION OF THE INVENTION

The invention is a simple machine for lifting a heavy truck hood, embodied as a telescoping lever to be placed on a flat surface, preferably the ground or the truck's front bumper. The device is embodied as at least two straight, cylindrical components, an outer tube and an inner tube, wherein each tube comprises a plurality of clip holes that overlay one another. Each tube will be made of metal, preferably aluminum or steel. In an alternate embodiment, the tubes are made of high-tensile strength rigid polymer.

The outer tube comprises a foot end and an open end. The inner tube extends through the open end, while the foot end is attached to a foot component, which is placed on the flat surface. Preferably, the foot is attached via a swivel mechanism, allowing the foot to stay in full contact with the flat surface while the user pulls on the device to lever the truck hood upward. The foot may be embodied as a circle, square or rectangle, or a wedge-shaped semicircle, wherein the foot can rock forward and backward on the flat surface while maintaining contact with the flat surface. In each case, the foot may be coated with rubber, an elastomer or other tacky polymer to improve its purchase on the flat surface and prevent slippage.

As the inner tube is pulled outward from the outer tube to extend the device, the inner tube clip holes slide past the outer tube clip holes to create a telescoping mechanism. Once a pair of holes are aligned, a clip is inserted between them to lock the clip in place. In a preferred embodiment, two or more clips may be inserted simultaneously for greater stability. The clips may be metallic or plastic inserts, but may also be embodied as spring-loaded push-button snaps or a similar mechanism.

In an alternate embodiment, more than two telescoping tubes are employed to effect a greater range of extension.

Each of a hood strap and a hand strap will be attached to the upper portion of the inner tube. Attachment to the tube may be accomplished either by tying the strap around the tube, threading the strap through holes in the tube, or by using a carabiner or similar type of clip. Each strap will be constructed of polyester or a similar high-strength polymer with a tensile strength of 500 pounds or greater.

The free end of the hood strap will terminate in a hood strap clip to be attached either to the edge of the hood nearest the windshield or to the niche handle located in the hood. The clip will be constructed of metal or a high-strength rigid polymer sufficient to withstand the repeated lifting of a 500 pound or greater hood.

The free end of the hand strap will terminate in a loop or handle allowing a user to pull on the hand strap to exert the force necessary to lift the hood and pull it forward. Preferably, the strap will run through or around a handle made of metal or high-strength rigid polymer similar to that of the hood strap clip. Each strap will be adjustable in length.

In a preferred embodiment, the telescoping device tubing will have a diameter between 3″ and 6″ and a length between 30″ and 6′.

### DETAILED DESCRIPTION OF THE FIGURES

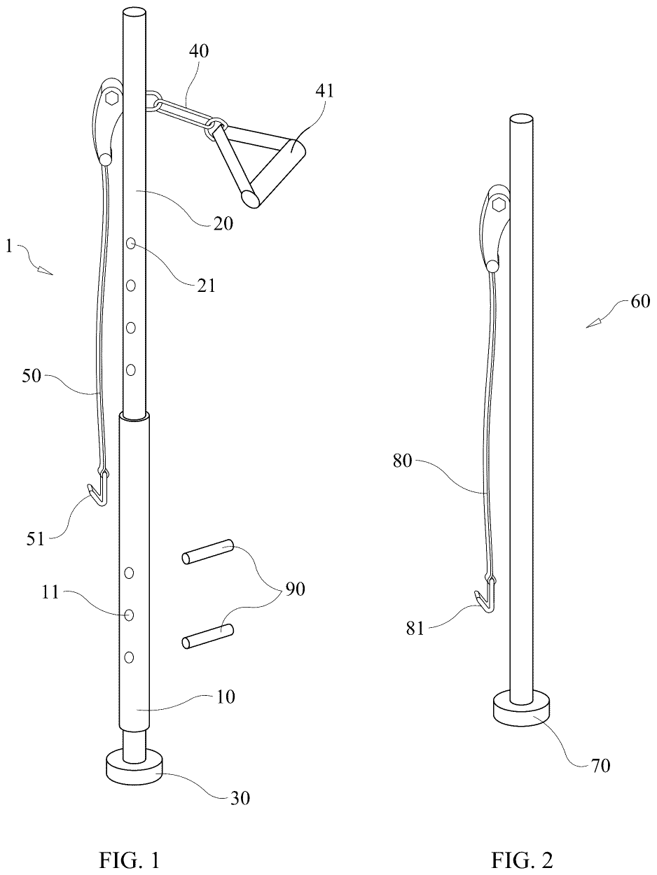

FIG. 1 shows a primary embodiment of a hood raising device 1 with an outer tube 10 and an inner tube 20, which is slidably inserted within the outer tube. Each tube is perforated with a line of clip holes 11,21, which are arranged so that the outer clip holes 11 will overlay the inner tube holes 21 as the parts slide apart, such that clips 90 may be inserted through the overlapping holes to connect and stabilize the two tubes. The effect will be a telescoping mechanism whereby the device can be elongated as the inner tube slides out, then collapsed again when the device is not in use for ease of storage. In an alternate embodiment, the clip holes on the inner tube are replaced with spring-loaded buttons to allow for snap-fit attachment between the two tubes.

The outer tube comprises one open end through which the inner tube is inserted and another end attached to a foot 30, wherein the foot is to be placed on a flat surface to stabilize the device for use. In a preferred embodiment, the foot is integrated with the outer tube and is circular and broader in diameter than the outer tube. In another embodiment, the foot is an oval or rectangle, optionally with a convex surface on the bottom, to increase contact between the ground and the foot. In an optional embodiment, the foot comprises a foot stem 31 which comprises a hinge or ratchet 32 allowing the stem to adjust forward and backward, allowing the foot to stay in contact with the ground as the tubing body moves back to lift the hood.

At or near the end of the inner tube that extends away from the outer tube will be attached each of a hood strap 50 and a hand strap 40. The hood strap will be adjustably connected to the inner tube with strap connector 52 and long enough to connect to the edge of the truck hood (not pictured) nearest the windshield, and will comprise a hood strap clip 51 for attachment to the hood. If the hood itself comprises a niche or handhold for raising the hood, the clip may also attach to the handhold.

Extending from the inner tube opposed the hood strap will be hand strap 40, ending in a hand strap handle 41, which a user can grab and pull to exert pressure to open the hood. Once the hood strap clip is attached to the hood and the foot 30 is placed on the ground or another stable surface, the user can grab the hand strap and/or the tubing and pull back. The connection of the foot of the device and the ground or other surface will create a fulcrum or fixed hinge, providing the user with the leverage force necessary to lift a 500 pound hood without risking injury or failure.

FIG. 2 is an alternate embodiment of a truck hood raising device 60, wherein the device comprises a single bumper bar tube 61 connected to a bumper bar foot 70, wherein the device is of a shorter length and is intended to use the truck's front bumper instead of the ground for leverage. At or near the end of the tube opposite the foot will be attached each of a bumper bar strap 80. The bumper bar strap will be adjustably connected to the inner tube with bumper bar strap connector 82 and long enough to connect to the edge of the truck hood (not pictured) nearest the windshield, and will comprise a hood strap clip 81 for attachment to the truck hood. If the hood itself comprises a niche or handhold for raising the hood, the clip may also attach to the handhold.

Each of hand strap and handle and a hinge/ratchet above the foot, similar to those described for device 1, can optionally be comprised with this shorter device version.

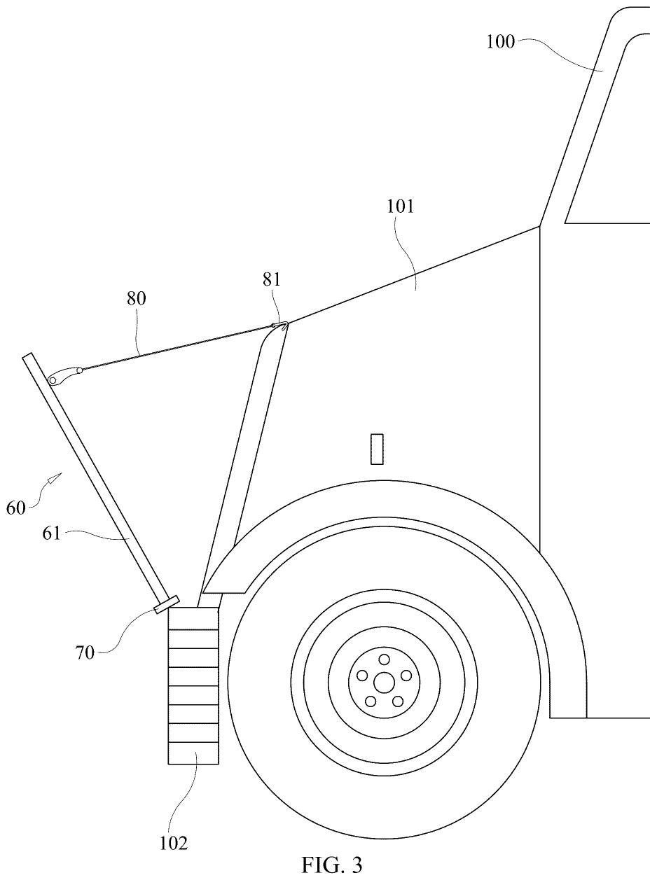

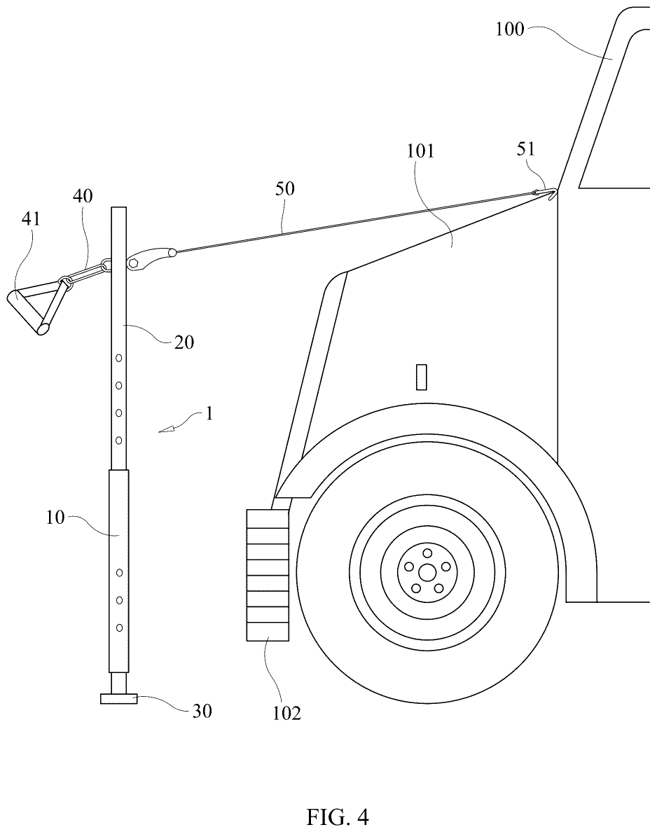

FIG. 3 shows the device 60 attached to a truck hood 101 via the bumper bar strap connector 82, bumper bar strap 80 and bumper bar strap clip 81. The bumper bar foot 70 creates a fulcrum with the truck bumper 102 to increase leverage.

FIG. 4 shows the device 60 attached to a truck hood 101 via the hood strap connector 52, hood strap 50 and hood strap clip 51. Inner tube 20 is shown extended from outer tube 10 such that the device is raised level with the hood. The foot 30 creates a fulcrum with the ground in front of the truck bumper 102 to increase leverage, and the hand strap 40 and hand strap handle 41 are available for a user to exert backward force.

### LIST OF REFERENCE NUMBERS

1 Hood raising device
10 Outer tube
11 Outer tube clip holes
20 Inner tube
21 Inner tube clip holes
30 Foot
31 Foot stem
32 Foot hinge/ratchet
40 Hand strap
41 Hand strap handle
50 Hood strap
51 Hood strap clip
52 Hood strap connector
60 Bumper bar
61 Bumper bar tube
70 Bumper bar foot
80 Bumper bar strap
81 Bumper strap clip
82 Bumper strap connector
90 Clips
100 Truck
101 Truck hood
102 Truck bumper

The references recited herein are incorporated herein in their entirety, particularly as they relate to teaching the level of ordinary skill in this art and for any disclosure necessary for the more common understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

I claim:

1. A truck hood raising device comprising each of an outer tube and an inner tube, wherein the inner tube extends from a first end of the outer tube, a foot attached to an end of outer tube, a hood strap and a hand strap, each attached to the inner tube, wherein the hood strap comprises a hood strap clip for attachment to a truck hood and the hand strap comprises a hand strap handle to be pulled by a user.

2. The truck hood raising device of claim 1, further comprising a line of outer tube clip holes and a line of inner tube clip holes which slidably overlay as the inner tube is pulled from within the outer tube, and clips which insert into the overlaid clip holes.

3. The truck hood raising device of claim 2, wherein the clips are push-button snaps.

4. The truck hood raising device of claim 1, wherein the foot is covered in rubber or an elastomer.

5. The truck hood raising device of claim 1, wherein the foot comprises a foot stem with a hinge or ratchet.

6. The truck hood raising device of claim 1, wherein each of the hand strap and hood strap are attached to the inner tube by a clip, and each strap is comprised of high-strength polymer with a tensile strength of 500 pounds or greater.

7. The truck hood raising device of claim 1, comprising a single tube.

8. A method of raising a truck hood using the truck hood raising device of claim 1, comprising the steps of:
a. Extending the inner tube from the outer tube to the desired height and snapping the tubes into place;
b. Placing the foot onto the ground in front of a truck's front bumper;
c. Attaching the hood strap clip to the truck's hood; and
d. Pulling the hand strap handle in a direction away from the truck hood while maintaining a connection between the foot and the ground until the hood is in a full upright and open position.

9. The method of claim 8, comprising the step:
d. Pulling the inner and/or outer tube in a direction away from the hood while maintaining a connection between the foot and the ground until the hood is in a full upright and open position.

10. A method of raising a truck hood using the truck hood raising device of claim 7, comprising the steps of:
a. Extending the inner tube from the outer tube to the desired height and snapping the tubes into place;
b. Placing the foot onto a truck's front bumper;
c. Attaching the hood strap clip to the truck's hood; and
d. Pulling the inner and/or outer tube in a direction away from the hood while maintaining a connection between the foot and the ground until the hood is in a full upright and open position.
